(19) United States
(12) Patent Application Publication
(10) Pub. No.: US 2009/0038815 A1
(43) Pub. Date: Feb. 12, 2009

(54) POWER HAND TOOL

(75) Inventors: Wen-Har Lin, Yilan County (TW); Yuan-Chi Hsu, Jhonghe City (TW)

Correspondence Address: PAI PATENT & TRADEMARK LAW FIRM, 1001 FOURTH AVENUE, SUITE 3200, SEATTLE, WA, 98154, US

(73) Assignee: NATIONAL ENERGY TECHNOLOGY CO., LTD., Banqiao City (TW)

(21) Appl. No.: 11/925,639

(22) Filed: Oct. 26, 2007

(30) Foreign Application Priority Data
Aug. 7, 2007 (TW) 96129051

(51) Int. Cl. B25D 16/00

(52) U.S. Cl. 173/104

(57) ABSTRACT

A power hand tool is disclosed to include a Li-battery set, an electric power storage device electrically connected in parallel to the Li-battery set, a motor, a power switch electrically connected between the motor and the electric power storage device and operable to switch on/off electric connection between the motor and the electric power storage device, a speed reducing gear set coupled to the output shaft of the motor, and an impact mechanism movable in a predetermined direction by the speed reducing gear set. When the power switch is switched on to electrically connect the electric power storage device to the motor, the motor is started to rotate the output shaft and the speed reducing gear set, causing the speed reducing gear set to move the impact mechanism and to further provide an impact force.

### BACKGROUND OF THE INVENTION

1. Field of the Invention

The present invention relates to power hand tools, and more particularly to a Li battery-operated power hand tool.

2. Description of the Related Art

A power hand tool, such as power screwdriver, power saw, or the like directly uses electric power for its operation. Unlike a conventional pneumatic hand tool that uses an air compressor to produce compressed air and a gas tube to guide in compressed air for working, an electric hand tool is practical for different applications.

According to the type of the power source used, regular power hand tools can be classified into AC power hand tools and DC power hand tools. An AC power hand tool uses a power cable to obtain the necessary working voltage from city power supply. When using an AC power hand tool, the user can start the operation after connecting the power cable of the AC power hand tool to an electric outlet. However, due to the limited length of the power cable, the user cannot freely carry the AC power hand tool to a working site far away from an electric outlet. Therefore, an AC power hand tool has a limited working distance. A DC power hand tool can be carried to any desired place for working conveniently.

A regular DC power hand tool generally comprises a battery pack, a motor, and a driving mechanism. The battery pack provides DC power supply to the motor, causing the motor to rotate the driving mechanism at a predetermined speed for drilling holes or providing an impact function. Nickel-hydrogen battery, nickel-cadmium battery, and Li battery are commonly used with regular DC power hand tools. For the advantages of lightweight and high capacity, Li battery is popularly used in regular consumer electronic products.

Because of the limitation of low transient charge/discharge capacity, a Li battery is not suitable for use in a DC power hand tool using a high output motor to provide a high impact force. Therefore, regular Li battery-operated power hand tools are used for light load applications only, but are impractical for works that require a high impact force or torque. Further, a Li battery generates heat during charging or discharging. When a Li battery is used for a high load work, the power of the Li battery will be used out soon, thus shortening the service life of the Li battery.

### SUMMARY OF THE INVENTION

The present invention has been accomplished under the circumstances in view. It is therefore one object of the present invention to provide a power hand tool which uses a Li battery set to provide the necessary working voltage. It is another object of the present invention to provide a Li battery-operated power hand tool which provides a high transient torque and a high impact force. It is still another object of the present invention to provide a Li battery-operated power hand tool which has the advantages of high power transmission efficiency and long service life.

To achieve these and other objects of the present invention, the power hand tool comprises a Li-battery set; an electric power storage device electrically connected in parallel to the Li-battery set; a motor, the motor having an output shaft; a power switch electrically connected between the motor and the electric power storage device and operable to switch on/off electric connection between the motor and the electric power storage device; a speed reducing gear set coupled to the output shaft of the motor; and an impact mechanism movable in a predetermined direction by the speed reducing gear set. When the power switch is switched on to electrically connect the electric power storage device to the motor, the motor is started to rotate the output shaft and the speed reducing gear set, causing the speed reducing gear set to move the impact mechanism and to further provide an impact force.

### BRIEF DESCRIPTION OF THE DRAWINGS

FIG. 1 is an elevational view of a power hand tool in accordance with the present invention.

FIG. 2 is a sectional view of the present invention, showing the internal structure of the power hand tool.

FIG. 3 is a circuit block diagram of the power hand tool according to the present invention.

### DETAILED DESCRIPTION OF THE INVENTION

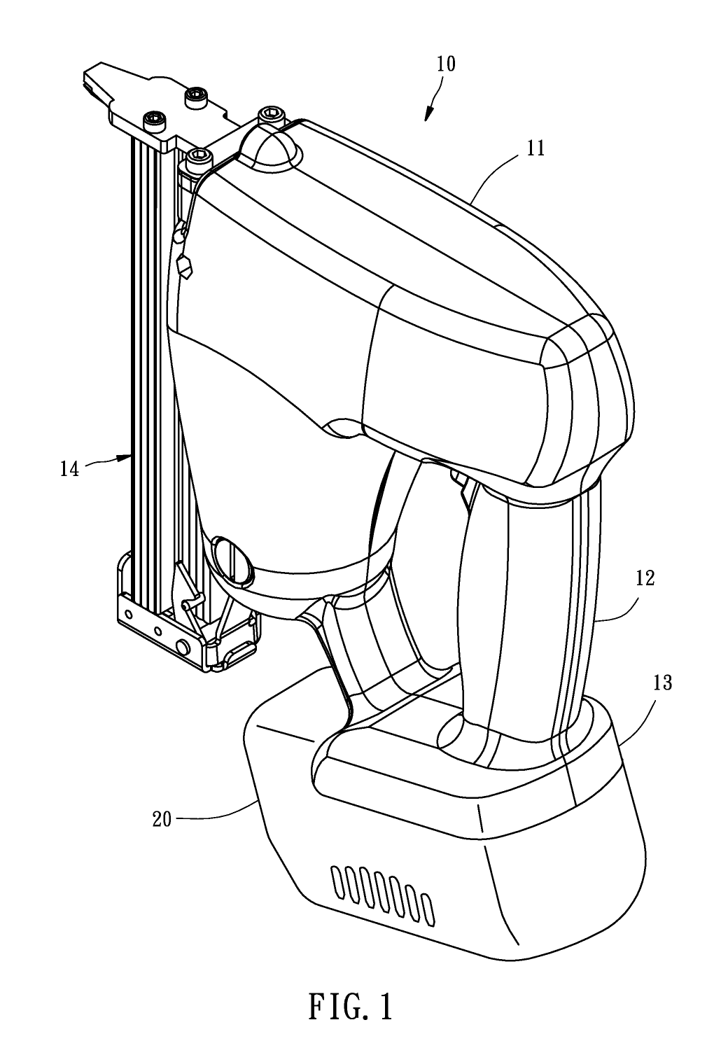

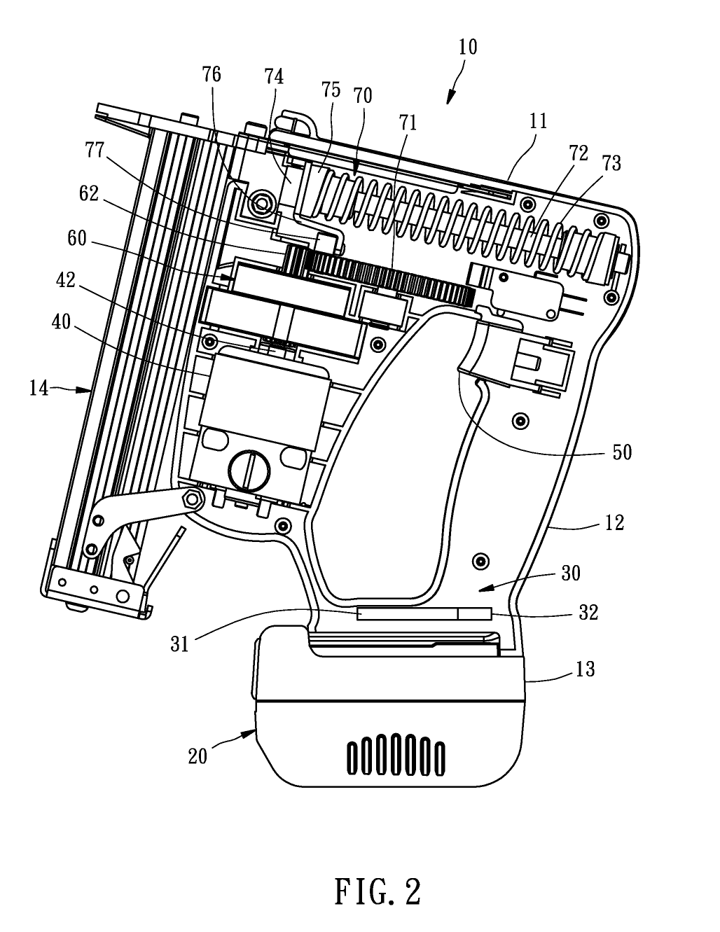

Referring to FIGS. 1 and 2, a power hand tool in accordance with the preferred embodiment of the present invention is power nail gun. The power nail gun comprises a housing 10, a Li-battery pack 20, an electric power storage device 30, a motor 40, a power switch 50, a speed reducing gear set 60, and an impact mechanism 70.

The housing 10 is made out of a high strength material, comprising an accommodation chamber 11, a grip 12, and a connecting portion 13. A nail magazine 14 is provided at the front side of the accommodation chamber 11. The grip 12 extends from the rear side of the accommodation chamber 11. The connecting portion 13 is disposed at the bottom side of the grip 12 and the accommodation chamber 11.

The Li-battery pack 20 is detachably attached to the connecting portion 13 of the housing 10. According to this embodiment, the Li-battery pack 20 is a metal series Li battery, for example, lithium iron phosphate (LiFePO₄) battery.

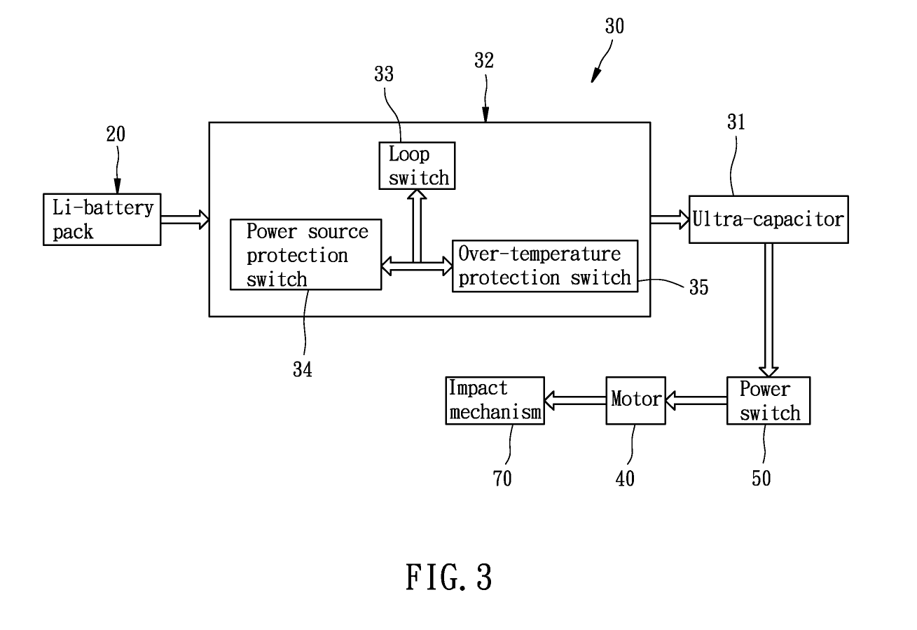

The electric power storage device 30 comprises an ultra-capacitor 31 and a circuit unit 32. According to this embodiment, the metal electrodes of the ultra-capacitor 31 are coated with a layer of metal coating such as molybdenum nitride, iron nitride, or titanium nitride for the advantage of rapid discharge, high capacitance, and high current and power output. The electric power storage device 30 is mounted inside the housing 10 near the connection between the grip 12 and the connecting portion 13. As shown in FIG. 3, the circuit unit 32 comprises a loop switch 33, a power source protection switch 34, and an over-temperature protection switch 35. The ultra-capacitor 31 is electrically connected to the circuit unit 32, and then electrically connected in parallel to the Li-battery pack 20.

The power switch 50 is installed in the grip 12 of the housing 10. The power switch 50 is electrically connected to the ultra-capacitor 31. When the user holds the grip 12, he/she can conveniently press the power switch 50.

The motor 40 is mounted inside the accommodation chamber 11 of the housing 10 and electrically connected to the power switch 50. The speed reducing gear set 60 is coupled to the output shaft 42 of the motor 40. When the user presses the power switch 50 to electrically connect the power switch 50 to the ultra-capacitor 31, the motor 40 and the electric power storage device 30 are electrically connected, and electric energy of the ultra-capacitor 31 is outputted to the motor 40, thereby starting the motor 40. When the motor 40 is started, the output shaft 42 is rotated at a high speed, driving the speed reducing gear set 60 to provide a high output torque through its output gear 62.

The impact mechanism 70 is mounted in the top side inside the accommodation chamber 11 of the housing 10. The impact mechanism 70 comprises a transmission gear 71, a guide rod 72, a spring 73, and an impact head 74. The transmission gear 71 is rotatably mounted inside the accommodation chamber 11 and meshed with the output gear 62 of the speed reducing gear set 60. The guide rod 72 is mounted inside the accommodation chamber 11. The spring 73 is sleeved onto the guide rod 72, having a front end fixedly mounted with a slide 75 that is movable along the guide rod 72 and a rear end fixedly connected to the guide rod 72. The slide 75 is mounted with an actuating rod 76. The actuating rod 76 extends from the slide 75 in a direction toward the transmission gear 71, and can be moved with the slide 75 to abut against a protruding portion 77 of the transmission gear 71 or apart from the protruding portion 77 of the transmission gear 71. The impact head 74 is disposed in front of the slide 75 of the spring 73.

When the user presses the power switch 50, electric energy is outputted from the electric power storage device 30 to the motor 40 to start the motor 40, causing the motor 40 to rotate the speed reducing gear set 60, and therefore a high torque is outputted through the output gear 62 of the speed reducing gear set 60. During rotation of the output gear 62, the transmission gear 71 is synchronously rotated, causing the protruding portion 77 of the transmission gear 71 to move along a circular path and to push the actuating rod 76. When the protruding portion 77 of the transmission gear 71 pushes the actuating rod 76, the slide 75 is moved along the guide rod 72 to compress the spring 73, causing the spring 73 to produce a spring force. When the protruding portion 77 is moved away from the actuating rod 76 during continuous rotation of the transmission gear 71, the spring force of the spring 73 immediately pushes the slide 75 forwards toward the front side of the housing 10 to force the impact head 74 against the nail in the nail magazine 14, thereby driving the nail out of the nail magazine 14 into the workpiece.

As stated above, the ultra-capacitor 31 of the electric power storage device 30 provides a relatively higher energy density and power density. When the Li-battery set 20 is electrically connected in parallel to the electric power storage device 30 to provide power supply to the motor 40, the output electric power of the electric power storage device 30 drives the high-speed high-load motor 40 to rotate the speed reducing gear set 60 and to further move the high elastic coefficient spring 73, causing the high elastic coefficient spring 73 to produce a high spring force for nailing.

By means of the aforesaid arrangement, the power hand tool of the present invention provides a relatively higher transient torque and impact force.

Further, the output power of the Li-battery set 20 is stored in the ultra-capacitor 31 of the electric power storage device 30 at first, and the ultra-capacitor 31 provides electric energy to the motor 40 for working. Because the Li-battery set 20 does not output battery power to the motor 40 directly, the invention reduces the load on the Li-battery set 20. Further, the loop switch 33 of the circuit unit 32 of the electric energy storage device 30 provides short circuit protection. The power source protection switch 34 provides the Li-battery set 20 with overcharge protection and over-discharge protection. The over-temperature protection switch 35 provides the Li-battery set 20 with over temperature protection during charge or discharge mode. Therefore, the circuit unit 32 greatly improves the power transmission efficiency of the Li-battery set 20, thereby extending the service life of the Li-battery set 20.

In the aforesaid embodiment, the invention is applied to an electric nail gun. However, this is not a limitation. Actually, the invention is applicable to any of a variety of power hand tools that require a high transient torque or power.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A power hand tool comprising:
a Li-battery set;
an electric power storage device electrically connected in parallel to said Li-battery set;
a motor, said motor having an output shaft;
a power switch electrically connected between said motor and said electric power storage device and operable to switch on/off electric connection between said motor and said electric power storage device;
a speed reducing gear set coupled to said output shaft of said motor; and
an impact mechanism movable in a predetermined direction by said speed reducing gear set;
wherein when said power switch is switched on to electrically connect said electric power storage device to said motor, said motor is started to rotate said output shaft and said speed reducing gear set, causing said speed reducing gear set to move said impact mechanism and to further provide an impact force.

2. The power hand tool as claimed in claim 1, wherein said electric power storage device comprises an ultra-capacitor and a circuit unit, said circuit unit comprising a loop switch, said ultra-capacitor being electrically connected to said circuit unit and then electrically connected in parallel to said Li-battery set.

3. The power hand tool as claimed in claim 1, wherein said electric power storage device comprises an ultra-capacitor and a circuit unit, said circuit unit comprising a power source protection switch, said ultra-capacitor being electrically connected to said circuit unit and then electrically connected in parallel to said Li-battery set.

4. The power hand tool as claimed in claim 1, wherein said electric power storage device comprises an ultra-capacitor and a circuit unit, said circuit unit comprising an over-temperature protection switch, said ultra-capacitor being electrically connected to said circuit unit and then electrically connected in parallel to said Li-battery set.

5. The power hand tool as claimed in claim 1, wherein said electric power storage device comprises an ultra-capacitor, said ultra-capacitor comprising a plurality of metal electrodes respectively coated with a metal coating prepared from molybdenum nitride, iron nitride, or titanium nitride.

6. The power hand tool as claimed in claim 1, wherein said impact mechanism comprises a guide rod, an impact head, and a spring mounted on said guide rod and adapted to drive said impact head, said spring having a first end affixed to said guide rod and a second end movable by said speed reducing gear set along said guide rod for driving said impact head.

7. The power hand tool as claimed in claim 6, wherein said impact mechanism further comprises a slide fastened to the second end of said spring and movable along said guide rod, and an actuating rod affixed to said slide and extending from said slide in direction toward said speed reducing gear set; said speed reducing gear set comprises a protruding portion movable along a circular path for stopping against said actuating rod to move said slide along said guide rod.

8. The power hand tool as claimed in claim 1, further comprising a housing, said housing comprising an accommodation chamber, a grip extending from a rear side of said accommodation chamber, and a connecting portion disposed between said grip and said accommodation chamber and adapted to detachably holding said Li-battery set, said accommodation chamber holding said impact mechanism on the inside adjacent to said nail magazine and having a front side provided with a nail magazine.
